(19) United States
(12) Patent Application Publication
(10) Pub. No.: US 2011/0142251 A1
(43) Pub. Date: Jun. 16, 2011

(54) LOW FREQENCY ELECTROACOUSTICAL TRANSDUCING IN A VEHICLE

(76) Inventor: Michael D. Rosen, Weston, MA (US)

(21) Appl. No.: 13/026,844

(22) Filed: Feb. 14, 2011

Related U.S. Application Data
(63) Continuation of application No. 11/551,410, filed on Oct. 20, 2006.

(51) Int. Cl. H04B 1/00

(52) U.S. Cl. 381/86

(57) ABSTRACT

An instrument panel is structured to separate a main cabin of a vehicle from a volume behind the instrument panel. The instrument panel has multiple leak paths through which air can travel between the main cabin and the volume behind the instrument panel. An electroacoustical transducer is mounted in the instrument panel and operable to radiate low-frequency acoustic energy into the volume behind the instrument panel. The low-frequency energy radiated by the electroacoustical transducer in the volume behind the instrument panel propagates into the main cabin via the multiple leak paths.

### CLAIM OF PRIORITY

This application is a continuation of and claims priority to U.S. patent application Ser. No. 11/551,410, the entire contents of which are incorporated here by reference.

### BACKGROUND OF THE INVENTION

Automotive sound systems typically include multiple loudspeakers positioned in various locations around the passenger compartment of the vehicle. Typical loudspeaker locations include the vehicle door panels and the interior trim panels. Low-frequency reproducing speakers, also known as woofers, are typically located in the rear package shelf of a vehicle. The rear package shelf acts as a baffle between the passenger compartment and the trunk of the vehicle.

### SUMMARY OF THE INVENTION

In one aspect, the invention is embodied in an apparatus for generating low frequency acoustic signals in a vehicle having an instrument panel. The apparatus includes a baffle that is located at least partially within the instrument panel. An electroacoustical transducer is mechanically coupled to the baffle. The electroacoustical transducer generates low frequency acoustic signals that radiate into a cavity within the instrument panel and leak into the passenger compartment of the vehicle through one or more mechanical openings in the instrument panel.

In one embodiment, the mechanical openings do not include dedicated acoustic radiation paths for guiding the acoustic signals to the passenger compartment from the electroacoustical transducer. In one embodiment, the baffle is integrated with the instrument panel. In one embodiment, a structure is located within the instrument panel and the baffle is mechanically coupled to the structure to create an enclosure for the electroacoustical transducer. The enclosure can be a ported enclosure, a sealed enclosure, or a bass reflex enclosure, for example.

The apparatus can further include a transducer that is mechanically coupled to the electroacoustical transducer. The transducer generates acoustic signals in phase with the acoustic signals generated by the electroacoustical transducer. The transducer generates a mechanical vibration that at least partially cancels a mechanical vibration generated by the electroacoustical transducer.

The apparatus can also include an audio source having a user interface and an electronics unit that is remotely located from the user interface. The electroacoustical transducer can be located at least partially behind the user interface.

In one embodiment, the electroacoustical transducer radiates energy in a frequency range of between about 60 Hz to 80 Hz. In another embodiment, the electroacoustical transducer radiates energy in a frequency range of between about 20 Hz to 100 Hz. The baffle can be coupled to the instrument panel through at least one mechanical isolator.

The apparatus can also include a bass radiating transducer that is remotely located from the instrument panel. The bass radiating transducer radiates acoustic energy into the passenger compartment of the vehicle. The bass radiating transducer can be located in a rear package shelf, a vehicle door, a rear corner post, or a rear hatch of the vehicle, for example.

The electroacoustical transducer can include a radially magnetized cylindrical magnet transducer. The radially magnetized cylindrical magnet transducer can include a solid magnet or a segmented magnet. The electroacoustical transducer can include a moving magnet transducer. The electroacoustical transducer can include a cup-type motor structure.

In another aspect, the invention is embodied in an audio system for a vehicle. The audio system includes a user interface that is located in a passenger compartment of the vehicle. An electronics unit is remotely located from the user interface. The electronics unit controls the audio source. The audio system also includes a baffle that is located substantially behind an instrument panel of the vehicle. An electroacoustical transducer is mechanically coupled to the baffle. The electroacoustical transducer generates low frequency acoustic signals that radiate into a cavity within the instrument panel and leak into the passenger compartment of the vehicle through one or more mechanical openings in the instrument panel.

In one embodiment, the electroacoustical transducer radiates all the low frequency acoustic signals into a cavity within the instrument panel that leak into the passenger compartment of the vehicle only through one or more mechanical openings in the instrument panel. In one embodiment, the one or more mechanical openings do not include dedicated acoustic radiation paths for guiding the acoustic signals to the passenger compartment from the electroacoustical transducer.

The audio system can also include non-dedicated acoustic radiation paths that guide the acoustic signals to the mechanical openings in the instrument panel. The user interface can be coupled to a steering wheel of the vehicle. The user interface can alternatively be coupled to the instrument panel of the vehicle. The baffle can be located behind the user interface. The baffle can be coupled to the instrument panel through one or more mechanical isolators. The audio system can radiate bass signals from both front and rear of the vehicle. The audio system can radiate all bass signals from a single unit front low-frequency loudspeaker.

In one embodiment, the audio system can include an enclosure that is located within the instrument panel. The baffle is mechanically coupled to a structure to create the enclosure for the electroacoustical transducer. The enclosure can be a ported enclosure, a sealed enclosure, or a bass reflex enclosure, for example. In one embodiment, the enclosure includes an acoustic waveguide. A volume of the enclosure can be less than two liters. The enclosure can radiate acoustic waves in a frequency range of between about 60 Hz to 80 Hz. The enclosure can be mounted to the instrument panel through at least one mechanical isolator.

In one embodiment, the audio system also includes a bass radiating transducer that is remotely located from the instrument panel. The bass radiating transducer radiates acoustic energy into the passenger compartment of the vehicle. The bass radiating transducer can be located in a rear package shelf, a vehicle door, a rear corner post, or a rear hatch of the vehicle, for example.

In yet another aspect, the invention is embodied in a method for generating low frequency acoustic signals in a vehicle having an instrument panel. The method includes locating a baffle at least partially within the instrument panel. An electroacoustical transducer is mechanically coupled to the baffle. Low frequency acoustic signals are radiated from the electroacoustical transducer into a cavity within the instrument panel. The low frequency acoustic signals leak into the passenger compartment of the vehicle through one or more mechanical openings in the instrument panel.

The method can also include reducing a vibration in the baffle caused by the electroacoustical transducer with a transducer mechanically coupled to the electroacoustical transducer. The transducer is driven mechanically out of phase with the electroacoustical transducer and acoustically in phase with the electroacoustical transducer.

In one embodiment, non-dedicated acoustic radiation paths guide the acoustic signals to the mechanical openings in the instrument panel. The baffle can be integrated with the instrument panel. The baffle can be coupled to a structure to create an enclosure for the electroacoustical transducer. The enclosure can be substantially isolated from the instrument panel. The baffle can be substantially isolated from the instrument panel. A bass radiating transducer can be remotely located from the instrument panel. The bass radiating transducer radiates acoustic energy into the passenger compartment of the vehicle. The bass radiating transducer can be located in a rear package shelf, a vehicle door, a rear corner post, or a rear hatch of the vehicle, for example.

One aspect of the invention is embodied in an apparatus for generating low frequency acoustic signals in a vehicle having an instrument panel. The apparatus includes an electroacoustical transducer that is located behind the instrument panel. The electroacoustical transducer generates low frequency acoustic signals that radiate into a cavity within the instrument panel and leak into the passenger compartment of the vehicle through one or more mechanical openings in the instrument panel. The apparatus also includes a low frequency transducer that is located in a rear section of the passenger compartment. The low frequency transducer radiates low frequency acoustic signals to the passenger compartment of the vehicle.

In one embodiment, the one or more mechanical openings do not include dedicated acoustic radiation paths for guiding the acoustic signals to the passenger compartment from the electroacoustical transducer. In one embodiment, the electroacoustical transducer and the low frequency transducer are driven with identical audio signals. In another embodiment, the electroacoustical transducer and the low frequency transducer are driven with different audio signals. In one embodiment, at least one of the electroacoustical transducer and the low frequency transducer radiates energy in a frequency range of between about 60 Hz to 80 Hz. In another embodiment, at least one of the electroacoustical transducer and the low frequency transducer radiates energy in a frequency range of between about 20 Hz to 100 Hz. The low frequency transducer can be located in a rear package shelf, a vehicle door, a rear corner post, or a rear hatch of the vehicle, for example.

### BRIEF DESCRIPTION OF THE DRAWINGS

This invention is described with particularity in the detailed description. The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a perspective view of the interior of a vehicle having a vehicle instrument panel;

FIG. 2 is a perspective view of the interior of the vehicle with the control interface removed from the instrument panel;

FIG. 3A through FIG. 3F illustrate various configurations of low-frequency transducers according to the invention;

FIG. 4 is a perspective view of the interior of the vehicle according to another embodiment of the invention;

FIG. 5 illustrates a vehicle audio system according to one embodiment of the invention; and

FIG. 6 is a diagram of a multiple channel surround sound system for a vehicle according to the invention.

### DETAILED DESCRIPTION

It is advantageous in a vehicle audio system to generate low frequency acoustic signals from the front area of the passenger compartment. This improves the overall quality of low frequency acoustic signals compared to those that are generated purely only in the rear area of the passenger component. For example, a bass transducer located in the front of the passenger compartment can generate low frequency acoustic signals that enhance the various low frequency modes in the passenger compartment.

Unfortunately, the volume required to produce adequate low frequency acoustic signals from the front of the vehicle is generally not available. For example, the instrument panel in most vehicles contains instruments, stereo equipment, computer electronics and climate control electronics, mechanics, and air conditioning duct work.

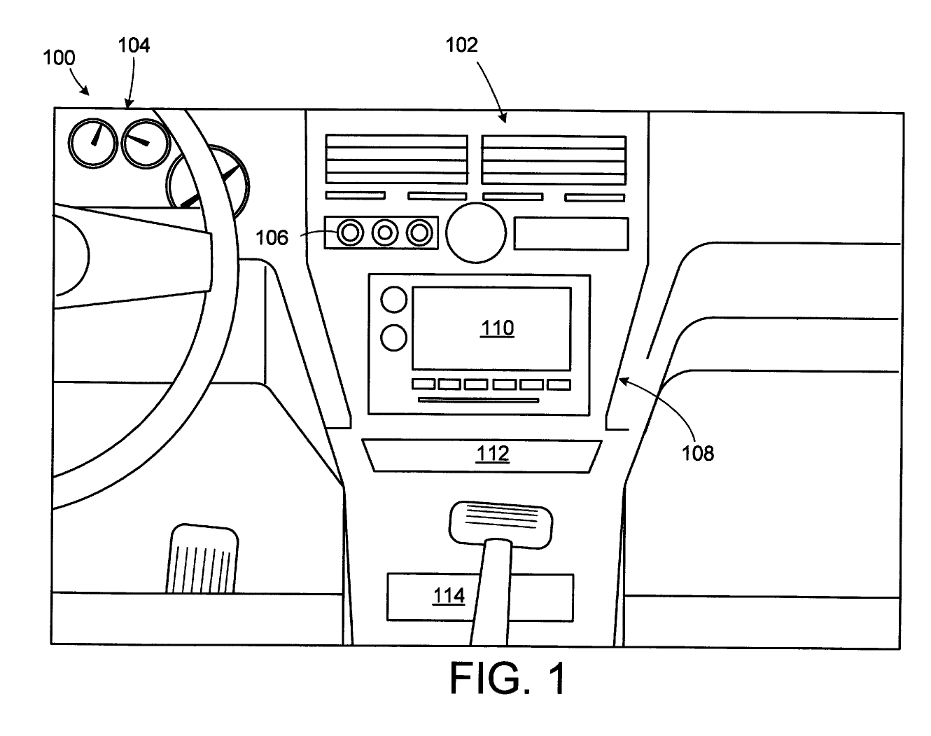

FIG. 1 is a perspective view of the interior of a vehicle 100 having a vehicle instrument panel 102. The instrument panel 102 contains displays 104 that show the speed of the vehicle, fuel level, coolant temperature, speed of the engine, as well as other vehicle parameters. The instrument panel 102 also includes the climate control system 106 and the audio system 108. Most factory-installed audio systems include a control interface 110 that is accessible to the driver and front passenger and an electronics unit (not shown) that is controlled by the control interface 110. For convenience, the control interface 110 is usually located near the center of the instrument panel 102 but is not limited to this location. For example, audio controls may be located on the steering wheel or on a console between the driver and passenger seats.

The electronics unit can include amplifier circuits, tuners, equalization circuits, memory as well as other circuitry. The electronics unit is typically located behind the control interface 110 within a volume space of the instrument panel 102.

In one embodiment, the electronics unit is positioned in a location other than behind the control interface 110. For example, the electronics unit can be remotely located from the instrument panel 102. Alternatively, the electronics unit can be located in the instrument panel 102, but in a location that is not directly behind the control interface 110.

In one embodiment, the volume of space behind the control interface 110 that is normally occupied by the electronics unit can be used by a low frequency transducer. The low frequency transducer can be coupled to a baffle. The low frequency transducer can alternatively be coupled to an enclosure. In one embodiment, a baffle having a transducer can be coupled to a separate structure which creates an enclosure to contain or alter the back wave radiation from the transducer. The baffle can be located at least partially within the instrument panel 102. A low frequency electroacoustical transducer is mechanically coupled to the baffle. The low frequency electroacoustical transducer generates low frequency acoustic signals that radiate into a cavity within the instrument panel 102 and leak into the passenger compartment of the vehicle through mechanical openings (see below for more details) in the instrument panel. The path length between the acoustic waves propagating from the back of the transducer and the acoustic waves propagating from the front of the transducer is chosen to reduce acoustic wave cancellation.

Low frequency acoustic signals are generally non-directional due to the wavelength at which they propagate. These low-frequency acoustic signals do not require dedicated transmission paths to effectively transmit acoustic energy into the passenger compartment of the vehicle. Instead, the low frequency acoustic energy is allowed to leak through the instrument panel into the passenger compartment. A typical instrument panel is not air-tight due to the many gaps in the instrument panel. For example, the instrument panel may be comprised of several sections joined together into a single panel. The seams between the sections are usually not air-tight and air can move through the instrument panel through these gaps. A gap may be created when a display or control does not tightly fit its cutout in the instrument panel. Other gaps in the instrument panel may be designed into the panel as vents or access holes to provide easy access during installation. These gaps are not intentionally designed to provide an acoustic path through the instrument panel and are hereinafter referred as non-acoustic paths. The inventors have discovered that these non-acoustic paths are sufficient for transmitting the low-frequency acoustic signals through the instrument panel into the passenger compartment. Furthermore, using the non-acoustic paths through the instrument panel eliminates the need for specifically-designed acoustic elements such as ducts, tubes, and waveguides. Elimination of these acoustic-specific elements frees up the space behind the instrument panel and also allows greater freedom in aesthetic design of the instrument panel. As used herein, “leak” refers to a non-acoustic path through the instrument panel. As used herein, “leaking” refers to the transmission of acoustic signals from an electroacoustical transducer to a listening area by the exclusive use of a non-acoustic path.

In some embodiments, various electronic devices can be coupled to the audio system. For example, the electronic devices can include CD changers, GPS receivers, navigation systems, MP3 players, DVD players, and/or satellite radio receivers. One or more of these electronic devices can be located behind the control interface 110. Some vehicle instrument panels can include one or more mounting slots 112, 114. The mounting slots 112, 114 can accommodate electronic devices.

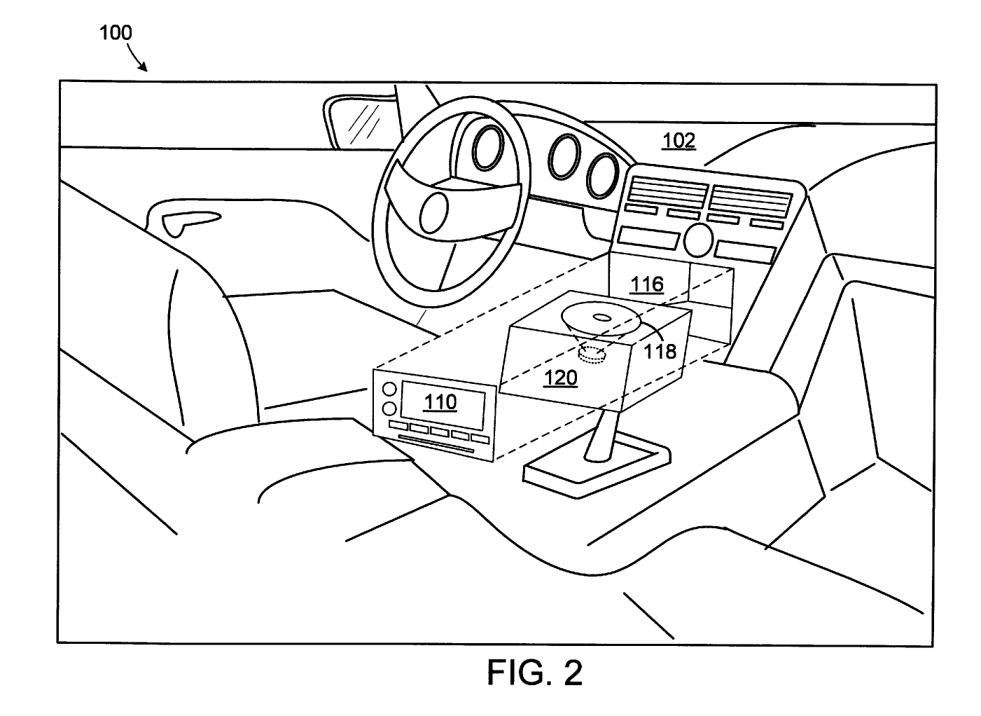

FIG. 2 is a perspective view of the interior of the vehicle 100 with the control interface 110 removed from the instrument panel 102. The electronics unit (not shown) is remotely located from behind the control interface 110. In one embodiment, the volume of space 116 behind the control interface 110 houses a low-frequency transducer 118 that can generate low-frequency acoustic signals. In one embodiment, the transducer 118 can be coupled to a baffle. The baffle can be coupled to a separate structure to create an enclosure 120 which can be further mechanically coupled to the instrument panel. The enclosure 120 can be less than two liters. The low-frequency transducer 118 can have a relatively small diameter, such as less than six inches. In other embodiments, multiple transducers can also be coupled to the baffle or enclosure 120. The enclosure 120 can embody a sealed enclosure, a ported enclosure, an enclosure including a waveguide structure, an enclosure including a passive radiator, or any other type of suitable enclosure.

The control interface 110 can include various controls, such as pushbuttons, rotary controls, scroll wheels, a touch screen including softkeys, and/or joysticks. An example of such a control interface 110 is described in pending U.S. patent application Ser. No. 10/262,349 filed on Jul. 23, 2003, entitled “System and Method for Accepting a User Control Input.”

The low-frequency transducer 118 generates low-frequency acoustic signals from the front of the passenger compartment of the vehicle 100. The low frequency transducer 118 preferably has a small diameter and operates in a frequency range of between about 20 Hz to 300 Hz. The enclosure 120 can have a volume of less than two liters. In one embodiment, the enclosure 120 can be located in the volume of space 116.

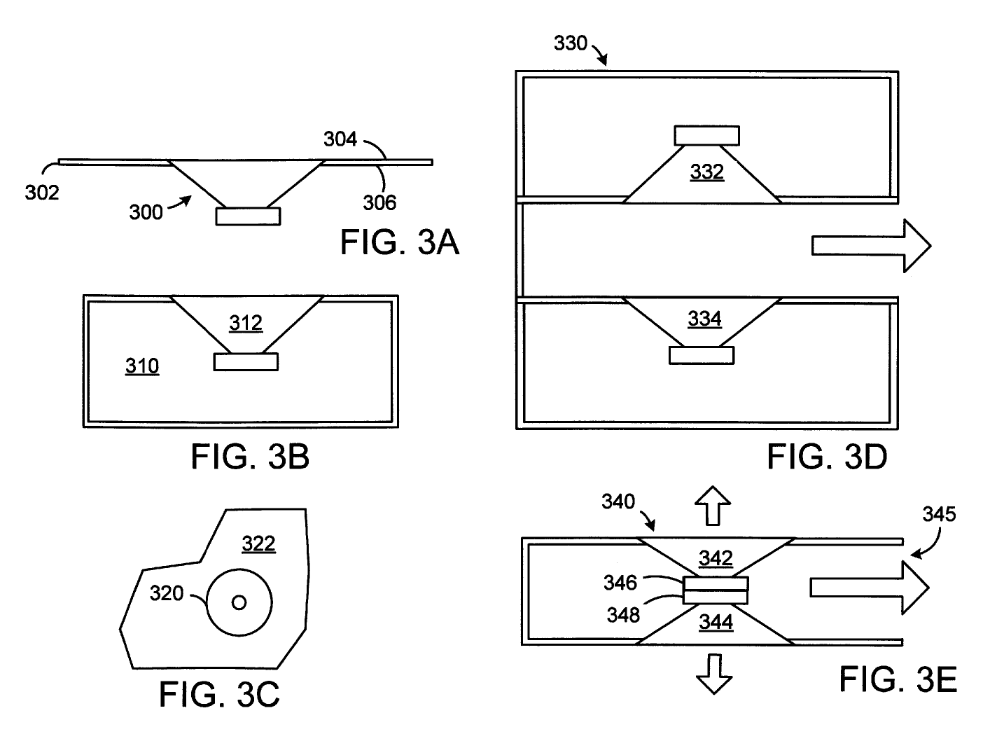

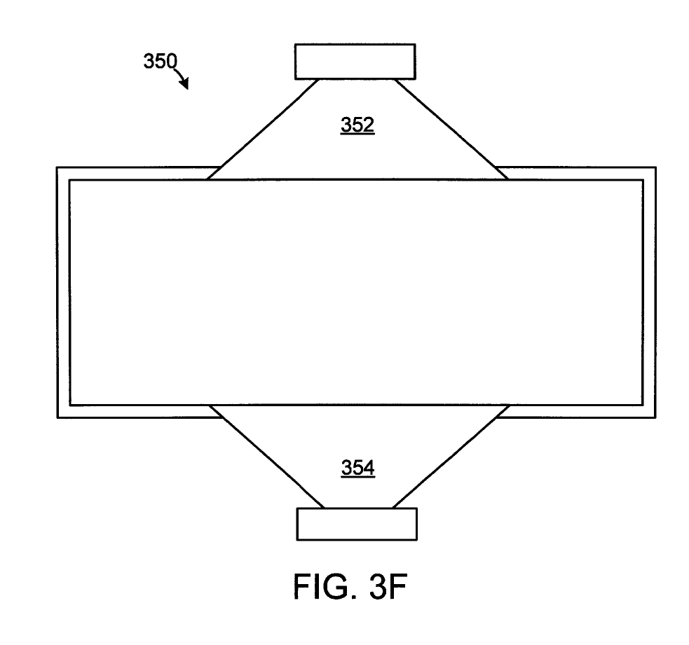

FIG. 3A through FIG. 3F illustrate various configurations of low-frequency transducers according to the invention. Specifically, FIG. 3A illustrates a low-frequency transducer 300 that is mounted in a baffle 302. The baffle 302 is positioned within an instrument panel of a vehicle such that one side 304 of the baffle 302 is acoustically isolated from the other side 306 of the baffle 302. In some embodiments, the baffle 302 does not fully isolate one side 304 from the other side 306. For example, the edges of the baffle 302 can include leakage paths. The baffle 302 increases the effective path length between the front and back sides of the transducer 300, which may increase radiation efficiency. The baffle 302 can be mounted in any suitable orientation. In one embodiment, the baffle 302 is coupled to an interior structure of the instrument panel thereby enclosing a portion of the interior volume of the instrument panel. In this embodiment, the baffle 302 and the interior structure of the instrument panel together act as an enclosure for the transducer 300.

FIG. 3B illustrates an embodiment of an enclosure 310 including a low-frequency transducer 312 according to one embodiment of the invention. The enclosure 310 is a sealed enclosure that is adapted to receive the low-frequency transducer 312. In one embodiment, the volume of the enclosure 310 is less than about two liters. In one embodiment, the diameter of the low-frequency transducer 312 is less than six inches. The enclosure 310 is shaped to maximize the interior volume of air, while corresponding to the mounting dimensions of the space provided within the instrument panel.

The enclosure 310 can be a sealed enclosure, a ported enclosure, or any other suitable type of enclosure. The enclosure 310 can also include one or more passive radiators and/or a waveguide structure. In one embodiment, acoustic energy from the transducer 312 as well as the port, passive radiator, or waveguide opening, if present, escapes into the passenger compartment of the vehicle through one or more mechanical openings such as seams, cracks, vents, and/or other voids in the instrument panel. Specifically, in some embodiments, sound from the transducer leaks into the passenger compartment solely through non-dedicated sound transmission paths that guide sound radiation from the transducer to the one or more mechanical openings in the instrument panel.

Input terminals of the low-frequency transducer 312 are coupled to output terminals of an electronics unit (not shown). The electronics unit can include a band pass filter or a low pass filter that transmits only low frequency audio signals to the transducer 312. Alternatively, the transducer 312 can include a cross-over network that prevents unwanted frequency signals from being reproduced by the low-frequency transducer 312.

FIG. 3C illustrates a low-frequency transducer 320 coupled to an irregular-shaped enclosure 322. The irregular-shaped enclosure 322 is designed to fit into a specific space within the instrument panel. For example, the irregular-shaped enclosure 322 can be designed such that its internal volume is maximized. The irregular-shaped enclosure 322 can be a sealed enclosure, a ported enclosure, an enclosure including a waveguide structure, an enclosure including a passive radiator, or any other type of suitable enclosure. In one embodiment, the volume of the irregular-shaped enclosure 322 is less than two liters.

As previously described, the instrument panel within which the enclosure 322 is mounted can be buzz/vibration-prone. This is due at least in part to the design and materials used to fabricate the instrument panel. For example, an energized transducer driver develops forces which cause the diaphragm of the transducer to move relative to the transducer frame. Some of these forces are transmitted through the frame to the enclosure 322 and through the enclosure 322 to the instrument panel. The energized transducer can cause the instrument panel to vibrate excessively, especially when the forces applied to the instrument panel are around its modal frequencies. This excessive vibration in the instrument panel can be acoustically perceived as unwanted buzzes and rattles causing degraded frequency response of radiated sound. Vibration canceling techniques can be used to mitigate the vibration. One such technique is described with reference to FIG. 3D.

FIG. 3D illustrates an enclosure 330 including two low-frequency transducers 332, 334. The low-frequency transducers 332, 334 are positioned on opposing surfaces of the enclosure 330. In one embodiment, the low-frequency transducers 332, 334 are substantially identical. The low-frequency transducers 332, 334 can be driven with identical audio signals. In one configuration, the transducers 332, 334 can be driven with audio signals having the same polarity. Alternatively, the transducers 332, 334 can be driven with audio signals having opposite polarity. The transducers 332, 334 are mounted such that they move mechanically out of phase when driven with the audio signals, and also radiate acoustically in phase. For example, the transducers 332, 334 can be driven mechanically out-of-phase such that forces generated by the first transducer 332 are at least partially cancelled by forces from the second transducer 334. This configuration is sometimes referred to as a dual opposed transducer configuration. Examples of dual opposed transducer configurations are described in U.S. Pat. No. 6,985,593 issued on Jan. 10, 2006 entitled “Baffle Vibration Reducing” and pending U.S. patent application Ser. No. 10/623,996 filed on Jul. 21, 2003 entitled “Passive Acoustical Radiating”, incorporated herein by reference.

The transducers 332, 334 do not have to be mounted in a parallel configuration to effectively reduce a resultant force on the enclosure. Transducers 332, 334 are not required to be identical to each other. For example, one of the transducers may be a moving mass that reduces the vibration generated by the other transducer but does not radiate a significant acoustic signal relative to the acoustic signal generated by the other transducer.

Other techniques for reducing vibration in the instrument panel according to the invention include mechanically isolating the enclosure 330 from the instrument panel or mechanically isolating a transducer from the baffle of the enclosure 330. For example, the enclosure 330 can be coupled to the instrument panel through one or more mechanical isolators. A suitable mechanical isolator can include, but is not limited to, an elastomer member, a spring, a dashpot, and a shock absorber. The mechanical isolator reduces the amplitude of the mechanical vibration that is coupled into the instrument panel. Examples of mechanical vibration isolation techniques are described in pending U.S. patent application Ser. No. 10/932,137 filed on Sep. 1, 2004 entitled “Audio System for Portable Device”, incorporated herein by reference. It should be noted that the vibration cancelling techniques described herein can be used with various enclosure configurations and transducers. In addition, a combination of the vibration cancellation techniques described above and mechanical isolation can also be used.

FIG. 3E illustrates an enclosure 340 including two low-frequency transducers 342, 344 according to another embodiment of the invention. The two low-frequency transducers 342, 344 are coupled together through motor structures 346, 348. This configuration is generally more compact than the configuration of FIG. 3D. In one configuration, the motor structures 346, 348 are separated. In this configuration, the baskets of the transducers 342, 344 are coupled to opposite sides of the enclosure 340.

In one embodiment, the low-frequency transducers 342, 344 are substantially identical. The low-frequency transducers 342, 344 can be driven with identical audio signals having the same phase. In this embodiment, acoustic energy from the front surface of the transducers 342, 344 and acoustic energy from the rear surface of the transducers 342, 344 combines to increase acoustic output energy. For example, in one configuration, the front surface of each transducer 342, 344 can radiate acoustic energy into the interior of the instrument panel while the rear surface of each of the transducers 342, 344 can radiate acoustic energy through the opening 345 indirectly into the passenger compartment of the vehicle through one or more non-dedicated mechanical openings in the instrument panel such as seams, cracks, vents, and/or other voids. The path length between the front and rear surfaces of the transducers 342, 344 to the passenger compartment is configured to maximize acoustic efficiency. As previously described, the transducers 342, 344 can be driven mechanically out-of-phase such that forces generated by the first transducer 342 are generally cancelled by forces from the second transducer 344.

FIG. 3F illustrates an enclosure 350 including two low-frequency transducers 352, 354 according to another embodiment of the invention. The two low-frequency transducers 352, 354 are coupled to opposite sides of the enclosure 350. Acoustic energy from the rear surfaces of the transducers 352, 354 radiate into the instrument panel while acoustic energy from the front surfaces of the transducers 352, 354 radiates into the enclosure 350. As previously described, the enclosure 350 can be any suitable enclosure type.

In one embodiment, the low-frequency transducers 352, 354 are substantially identical. The low-frequency transducers 352, 354 can be driven with identical audio signals that are substantially in phase. The transducers 352, 354 are mounted such that they move mechanically out of phase when driven with in phase electrical signals, and also radiate acoustically in phase. For example, the transducers 352, 354 can be driven mechanically out-of-phase such that forces generated by the first transducer 352 are generally cancelled by forces from the second transducer 354.

In one embodiment, in the various configurations of low-frequency transducers according to FIG. 3A through FIG. 3F, acoustic energy from the transducer(s) radiate into a cavity of the instrument panel and escapes into the passenger compartment of the vehicle through one or more mechanical openings such as seams, cracks, vents, and/or other voids in the instrument panel without any dedicated sound transmission path for guiding sound radiation from the transducer to the one or more mechanical openings.

It should be noted that all of the configurations described herein can include transducers having various motor structures. For example, radially magnetized cylindrical motor structures can provide increased motor force for a given size motor structure as compared to standard motor structures. The radially magnetized motor structure can include solid or segmented magnets. Additionally, the motor can include a moving coil or moving magnet structure. Other motor structures can also be used such as a pot type motor structure, a ceramic type structure having a donut shaped magnet, or any other suitable motor structure.

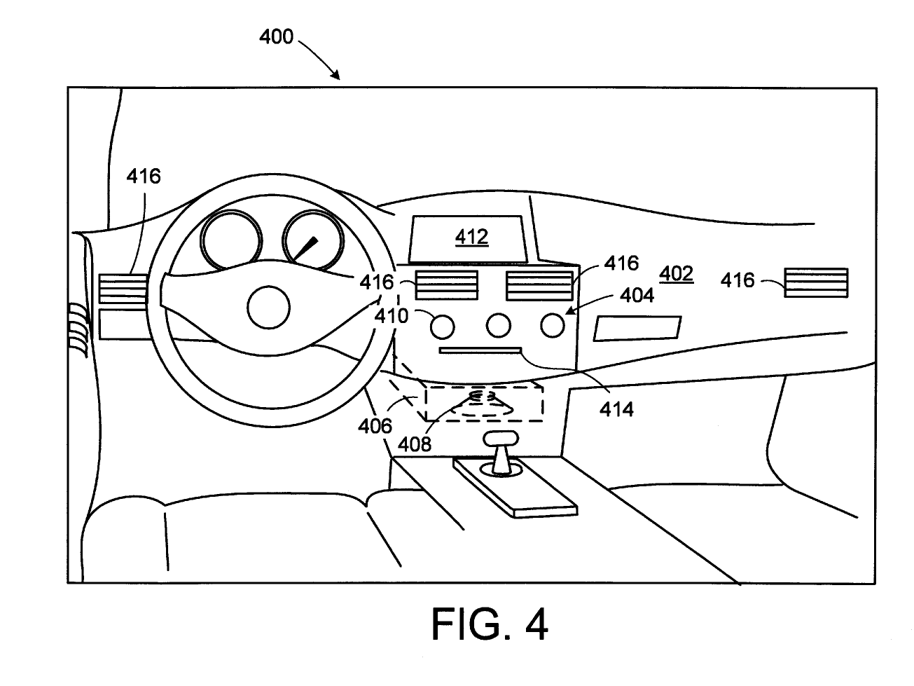

FIG. 4 is a perspective view of the interior of the vehicle 400 according to another embodiment of the invention. An instrument panel 402 includes a control interface 404. In this embodiment, an enclosure 406 including a low-frequency transducer 408 is located in a 1-DIN, 2-DIN or any suitably sized slot in the instrument panel 402. FIG. 4 illustrates that the enclosure 406 is not required to be located directly behind the control interface 404. The enclosure 406 can be positioned in any suitable unoccupied internal space within the instrument panel 402. The enclosure 406 can be a sealed enclosure, a ported enclosure, or any other suitable low-frequency enclosure type.

The control interface 404 includes at least one rotary control 410. A display 412 is located above the rotary control 410. A slot 414 is located below the rotary control 410. The slot 414 is designed to accept a compact disk (CD) or a digital video disk (DVD), for example.

The low-frequency electroacoustical transducer 408 located within the instrument panel 402 generates low frequency acoustic signals that radiate into a cavity within the instrument panel 402 and leak into the passenger compartment of the vehicle through mechanical openings in the instrument panel 402. In one embodiment, there are no dedicated acoustic radiation paths such as ducks, tubes, waveguides which guide the acoustic signals to the mechanical openings in the instrument panel 402. For example, acoustic signals generated by the transducer 408 only propagate through cracks, seams, and voids in the instrument panel 402.

In one embodiment, the acoustic signals can propagate through one or more climate control vents 416 in the instrument panel 402. This can present design challenges since the air handling ducts are generally well isolated from other components within the instrument panel and will not allow substantial acoustic energy to leak into them. It should be understood, however, that an air handling duct generally would not behave as a tuned acoustic waveguide for any low-frequency acoustic energy that leaks into it. Embodiments of the present invention take advantage of sound leaking through openings not designed for the purpose of conducting sound from inside the instrument panel to the passenger compartment. For example, these techniques do not rely on dedicated acoustic paths from the acoustic source within the instrument panel to the passenger compartment.

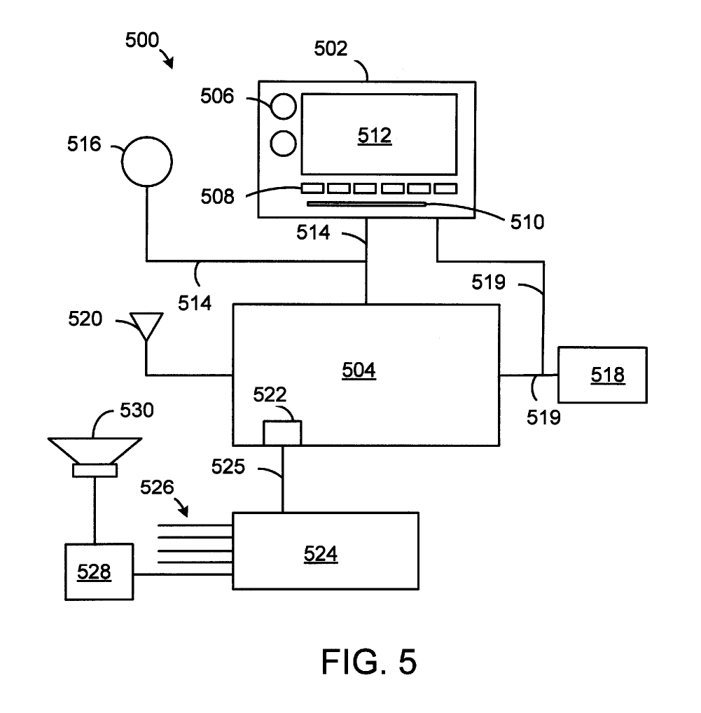

FIG. 5 illustrates a vehicle audio system 500 according to one embodiment of the invention. The vehicle audio system 500 includes a control interface 502 and an electronics unit 504. The electronics unit 504 can be remotely located from the control interface 502. The control interface 502 can include one or more rotary 506 and/or push button controls 508. The control interface 502 may include a slot 510 that is configured to accept a compact disk (CD) or a digital video disk (DVD), for example. In one embodiment, the control interface 502 can also include a display 512. The display 512 can be a liquid crystal display (LCD), cathode ray tube (CRT), or a plasma display, for example. The display 512 can be a touch screen display.

The control interface 502 is electrically coupled to the electronics unit 504 through a signal transmission line 514. In one embodiment, the signal transmission line 514 is a bus that couples various systems in the vehicle together. For example, the signal transmission line 514 can couple the central processing unit (CPU) 516 of the vehicle to the control interface 502 and the electronics unit 504. Although the connections between components are shown as hard-wired, wireless connections can also be used.

The control interface 502 and the electronics unit 504 can also be coupled to a power source 518 through one or more power lines 519. The power source 518 can include the battery and/or alternator of the vehicle. In one embodiment (not shown), the signal transmission line 514 can include a power line that can be coupled to the power source 518. The power source 518 can also be coupled to the CPU 516.

An antenna 520 is coupled to the electronics unit 504. For example, the antenna 520 can be an AM/FM antenna, a satellite antenna, a Bluetooth antenna, or a combination thereof.

The electronics unit 504 can also include an optical digital output terminal 522 that outputs an optical signal. The optical digital output terminal 522 is coupled to a signal processor 524 such as a 5.1 channel processor through an optical signal transmission line 525. The signal processor 524 receives the optical signal. The signal processor 524 can embody a digital signal processor (DSP) or can be fabricated from analog circuitry. The signal processor 524 can operate on the optical signal in various ways. For example, the signal processor 524 can provide decoding, alter the signal gain, and/or mix signals in order to create analog output signals. Analog output terminals 526 on the signal processor 524 output the analog output signals. In another embodiment, a non-optical output terminal can be coupled to a DSP through a wired electrical connection.

One or more amplifiers can be coupled to the analog output terminals 526. The amplifiers are connected to loudspeakers located throughout the passenger compartment of the vehicle. One such amplifier 528 is coupled to a low frequency transducer 530 that is located within the instrument panel of the vehicle.

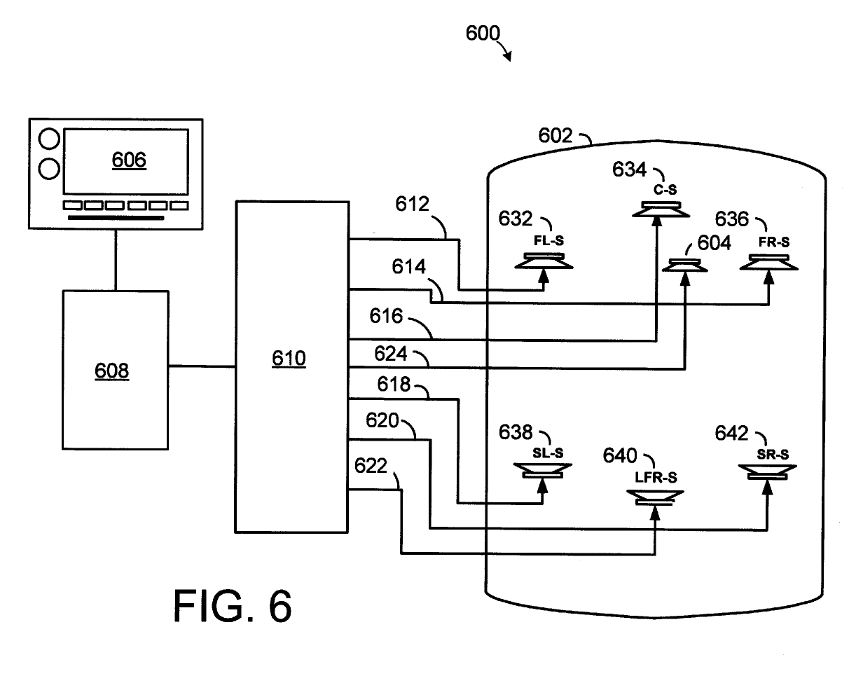

FIG. 6 is a diagram of a multiple channel surround sound system 600 for a vehicle 602 according to the invention. The multiple channel surround sound system 600 includes a low-frequency transducer 604 located in the instrument panel of the vehicle 602. In one embodiment, the low-frequency transducer 604 can reproduce frequencies in the range of about 20 Hz to 200 Hz. In one embodiment, the low-frequency transducer 604 can reproduce frequencies in the range of about 60 Hz to 80 Hz. Although FIG. 6 illustrates a multi-channel surround sound system, it should be understood that the principles and techniques described herein can also be used in a traditional stereo system.

The multiple channel surround system 600 includes a control interface 606 and an electronics unit 608. As previously discussed, the electronics unit 608 can be remotely located from the control interface 606. The electronics unit 608 is coupled to a signal processor 610. The signal processor 610 can perform various functions on audio signals that are received from the electronics unit 608. For example, the signal processor 610 can provide equalization and/or downmixing to the audio signals.

In one embodiment, the system 600 includes a plurality of discrete surround sound signals. For example, the plurality of signals can correspond to a front left (FL) channel 612, a front right (FR) channel 614, a center (C) channel 616, a surround left (SL) channel 618, a surround right (SR) channel 620, a bass or low frequency effects (LFE) channel 622, and a specific low-frequency channel 624 to drive the low-frequency transducer 604 located within the instrument panel. Although seven channels are shown and described, any number of channels can be utilized. For example, in one embodiment, the center channel 616 is removed. Alternatively, the system 600 can include a surround center channel (not shown).

Output signals from the signal processor 608 can be sent to spatially diverse transducers positioned in various locations within the vehicle 602. The transducers can include a front left speaker (FL-S) 632, a center speaker (C-S) 634, a front right speaker (FR-S) 636, a surround left speaker (SL-S) 638, a low-frequency rear speaker (LFR-S) 640 also referred to as a bass radiating transducer, a surround right speaker (SR-S) 642, and the low-frequency loudspeaker 604. The speakers can be installed in various locations throughout the vehicle 602. For example, the low-frequency loudspeaker 604 can be installed in the instrument panel and the bass radiating transducer 640 can be located in the rear package shelf of the vehicle 602. In other embodiments, the bass radiating transducer 640 can also located in a vehicle door, such as a rear vehicle door, a rear corner post, or a rear hatch of the vehicle. The bass radiating transducer 640 and the low-frequency loudspeaker 604 can be driven with the same low frequency signal or can be driven with different low frequency signals. In this implementation, low frequency sound can be generated from both front and rear locations in the vehicle 602. The front left speaker 632 and the front right speaker 636 can be mounted in the front left and front right door panels, respectively, of the vehicle 602. Any number of transducers can be installed in the vehicle 602 in various locations regardless of the number of signal channels in the system 600.

In one embodiment, low frequency performance is enhanced by radiating low frequency sound from both the front and the rear of the vehicle. This configuration provides greater flexibility for bass imaging management, such as providing enhanced perceived bass imaging or increased maximum low frequency output level, or both to passengers in both the front and rear seats of the vehicle.

In another embodiment, the bass radiating transducer 640 is omitted and all bass signals are radiated from the single unit front low-frequency loudspeaker 604.

Skilled artisans will appreciate that although various openings in the instrument panel are shown and described for radiating low frequency sound from the front of the passenger compartment of the vehicle, the low frequency transducer does not require existing or specifically designed dedicated vent openings for radiating low frequency sound. The low frequency sound can be leaked into the passenger compartment through any voids in the instrument panel.

While the invention has been particularly shown and described with reference to specific exemplary embodiments, it is evident that those skilled in the art may now make numerous modifications of, departures from and uses of the specific apparatus and techniques herein disclosed. Consequently, the invention is to be construed as embracing each and every novel feature and novel combination of features presented in or possessed by the apparatus and techniques herein disclosed and limited only by the spirit and scope of the appended claims.

What is claimed is:

1. An apparatus comprising:
an instrument panel structured to separate a main cabin of a vehicle from a volume behind the instrument panel, wherein the instrument panel has multiple leak paths through which air can travel between the main cabin and the volume behind the instrument panel; and
an electroacoustical transducer mounted in the instrument panel and operable to radiate low-frequency acoustic energy into the volume behind the instrument panel;
wherein low-frequency energy radiated by the electroacoustical transducer in the volume behind the instrument panel may propagate into the main cabin via the multiple leak paths.

2. The apparatus of claim 1 wherein the low frequency energy radiated by the electroacoustical transducer propagates into the main cabin solely via the multiple leak paths.

3. The apparatus of claim 1 wherein the electroacoustical transducer is coupled to the instrument panel through at least one mechanical isolator.

4. The apparatus of claim 1 wherein the leak paths include gaps between the instrument panel and one or more of a display or a control panel.

5. The apparatus of claim 1 wherein the instrument panel comprises multiple joined sections, and the leak paths include gaps in seams between sections of the instrument panel.

6. The apparatus of claim 1 wherein the leak paths include access holes in the instrument panel.

7. The apparatus of claim 1 wherein the electroacoustical transducer radiates energy in a frequency range of between about 20 Hz to 200 Hz.

8. The apparatus of claim 1 wherein the electroacoustical transducer radiates energy in a frequency range of between about 60 Hz to 80 Hz.

9. An audio system comprising:
an amplifier and a plurality of electroacoustical transducers structured to be mounted in an automobile having an instrument panel separating a main cabin of a vehicle from a volume behind the instrument panel, wherein the instrument panel has multiple leak paths through which air can travel between the main cabin and the volume behind the instrument panel;
the plurality of electroacoustical transducers comprising a low-frequency transducer structured to be mounted in the instrument panel and operable to radiate low-frequency acoustic energy into the volume behind the instrument panel;
wherein low-frequency energy radiated by the electroacoustical transducer in the volume behind the instrument panel may propagate into the main cabin via the multiple leak paths.

10. The apparatus of claim 9 wherein the low frequency energy radiated by the electroacoustical transducer propagates into the main cabin solely via the multiple leak paths.

11. The apparatus of claim 9 wherein the electroacoustical transducer is coupled to the instrument panel through at least one mechanical isolator.

12. The apparatus of claim 9 wherein the leak paths include gaps between the instrument panel and one or more of a display or a control panel.

13. The apparatus of claim 9 wherein the instrument panel comprises multiple joined sections, and the leak paths include gaps in seams between sections of the instrument panel.

14. The apparatus of claim 9 wherein the leak paths include access holes in the instrument panel.

15. The apparatus of claim 9 wherein the electroacoustical transducer radiates energy in a frequency range of between about 20 Hz to 200 Hz.

16. The apparatus of claim 9 wherein the electroacoustical transducer radiates energy in a frequency range of between about 60 Hz to 80 Hz.
